(19) United States
(12) Patent Application Publication
(10) Pub. No.: US 2024/0305677 A1
(43) Pub. Date: Sep. 12, 2024

(54) METHOD AND DEVICE FOR PROVIDING VOICE OPTION PROMPT

(71) Applicant: Acer Incorporated, New Taipei City (TW)

(72) Inventor: Wen-Cheng HSU, New Taipei City (TW)

(21) Appl. No.: 18/452,713

(22) Filed: Aug. 21, 2023

(30) Foreign Application Priority Data
Mar. 8, 2023 (TW) 112108412

(51) Int. Cl. H04L 65/1104; H04M 3/42

(52) U.S. Cl. CPC H04L 65/1104; H04M 3/42

(57) ABSTRACT

A method for providing voice option prompts is provided. The method is used in a switchboard device. The method includes receiving an incoming call from a client device. The method includes transmitting a voice option sound and a voice option prompt to the client device.

### CROSS REFERENCE TO RELATED APPLICATIONS

This application claims priority from Taiwan Patent Application No. 112108412, filed on Mar. 8, 2023, the disclosure of which is incorporated herein in its entirety by reference.

### BACKGROUND OF THE APPLICATION

### Field of the Application

The present disclosure generally relates to a method and a device for providing voice option prompts. More specifically, aspects of the present disclosure relate to a method and a device for providing voice option prompts between a switchboard device and a client device.

### Description of the Related Art

Early switchboard devices were all connected to traditional hand-held telephones, and users could listen to instructions with one hand-held handset, and dial numbers according to the instructions with the other hand. However, the manner of use of traditional switchboard devices becomes inconvenient when users are increasingly using mobile phones. The reasons are as follows.

1. The application software of the mobile extension is loaded on the users' mobile phones. The mobile phone mechanism does not have a handset, so the users cannot operate it while listening to the voice instructions. Therefore, the users need to put their mobile phones next their ears to listen to the instructions, and the users can remove the phone from their ears to operate the mobile phone after listening.

2. When the voice instruction is too lengthy (for example, the voice prompt of the credit-card or bank service switchboard), the user cannot immediately remember the content of the voice instruction, and this may cause an operation error.

Therefore, there is a need for a method and a device for providing voice option prompts to solve the problems listed above, and to improve the convenience of user operation.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method and a device for providing voice option prompts.

In an exemplary embodiment, a method for providing voice option prompts is provided. The method is used in a switchboard device. The method comprises receiving an incoming call from a client device. The method comprises transmitting a voice option sound and a voice option prompt to the client device.

In some embodiments, the voice option prompt comprises text and/or images.

In some embodiments, the voice option prompt is a Session Initiation Protocol (SIP) message.

In an exemplary embodiment, a method for providing voice option prompts is provided. The method is used in a client device. The method comprises transmitting an incoming call to a switchboard device. The method comprises receiving a voice option sound and a voice option prompt transmitted from the switchboard device. The method comprises playing the voice option sound and displaying the voice option prompt.

In an exemplary embodiment, a device for providing voice option prompts is provided. The device comprises one or more processors and one or more computer storage media for storing one or more computer-readable instructions. The processor is configured to drive the computer storage media to execute the following tasks. The following tasks comprise receiving an incoming call from a client device. The following tasks comprise transmitting a voice option sound and a voice option prompt to the client device.

In an exemplary embodiment, a device for providing voice option prompts is provided. The device comprises one or more processors and one or more computer storage media for storing one or more computer-readable instructions. The processor is configured to drive the computer storage media to execute the following tasks. The following tasks comprise transmitting an incoming call to a switchboard device. The following tasks comprise receiving a voice option sound and a voice option prompt transmitted from the switchboard device. The following tasks comprise playing the voice option sound and displaying the voice option prompt.

### BRIEF DESCRIPTION OF DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram illustrating a system for providing voice option prompts according to an embodiment of the present disclosure.

FIG. 2 is a flowchart illustrating a method for providing voice option prompts according to an embodiment of the present disclosure.

FIG. 3 is a flowchart illustrating a method for providing voice option prompts according to an embodiment of the present disclosure.

FIG. 4 is a schematic diagram showing a voice option prompt displayed as an image according to an embodiment of the present disclosure.

FIG. 5 illustrates a setting interface for setting voice option prompts on the switchboard device according to an embodiment of the present disclosure.

FIG. 6 illustrates a call interface for displaying voice option prompts on a client device according to an embodiment of the present disclosure.

FIG. 7 illustrates an exemplary operating environment for implementing embodiments of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

The embodiments of the present disclosure provide a method and a device for providing voice option prompts, which are used to transmit the voice option prompts along with the voice option sounds to the client device, so as to retain the traditional switchboard voice operation design and solve the inconvenience of users listening to voice option prompts through mobile extensions.

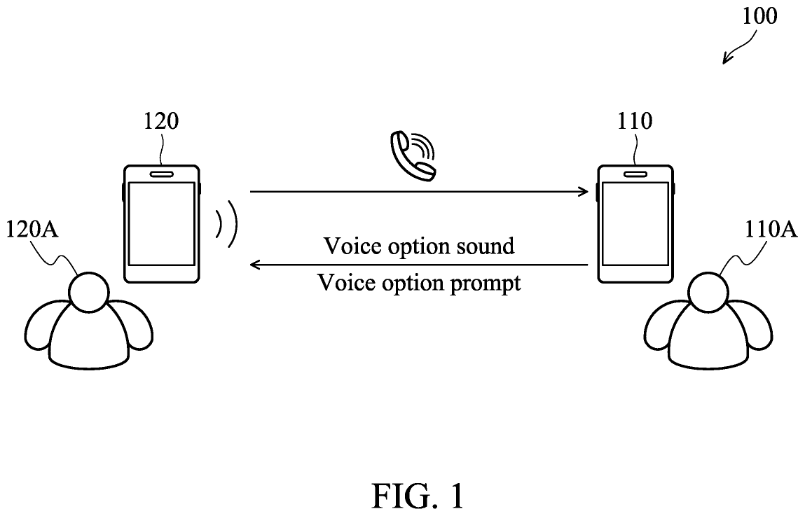

FIG. 1 is a schematic diagram illustrating a system 100 for providing voice option prompts according to an embodiment of the present disclosure. The system 100 may comprise a switchboard device 110 and at least one client device 120, wherein the switchboard device 110 is used by a user 110A, and the client device 120 is used by a user 120A.

The types of the switchboard device 110 and the client device 120 range from small handheld devices (e.g., mobile phones/portable computers) to large host systems (e.g., mainframe computers). Examples of portable computers comprise personal digital assistants (PDA), notebook computers and other devices.

The user 110A can first preset the voice option sound and the voice option prompt to be played through the switchboard device 110. The switchboard device 110 transmits a preset voice option sound and a voice option prompt to the client device 120 when receiving an incoming call 130 from one of the client devices 120.

When the client device 120 receives the voice option sound and the voice option prompt transmitted by the switchboard device 110, the client device 120 plays the voice option sound and displays the voice option prompt. The user 120A can transmit a Dual-Tone Multi-Frequency (DTMF) signal to the switchboard device 110 through the client device 120 after watching the voice option prompt.

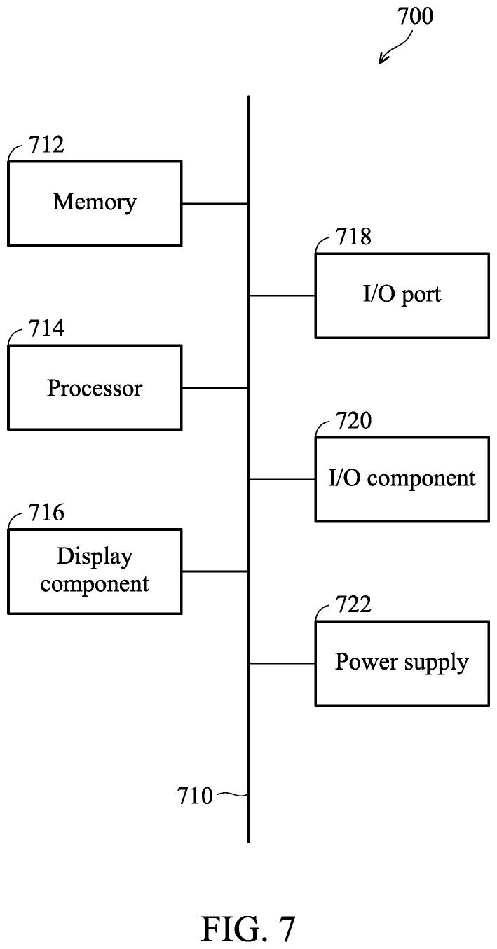

It should be understood that the switchboard device 110 and the client device 120 shown in FIG. 1 is an example of the system 100 for providing voice option prompts architecture. The switchboard device 110 and the client device 120 shown in FIG. 1 can be implemented via any type of computing device, such as the computing device 700 described with reference to FIG. 7, as shown in FIG. 7.

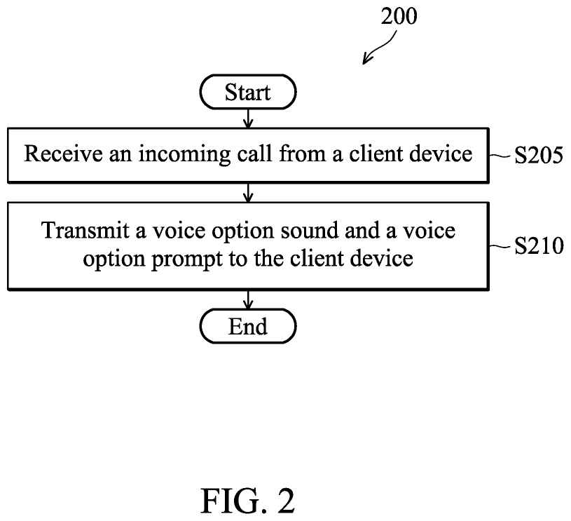

FIG. 2 is a flowchart illustrating a method 200 for providing voice option prompts according to an embodiment of the present disclosure. This method can be implemented by the switchboard device 110 of the system 100 for providing voice option prompts as mentioned in FIG. 1.

In step S205, the switchboard device receives an incoming call from a client device.

In step S210, the switchboard device transmits a voice option sound and a voice option prompt to the client device. In one embodiment, the voice option prompt comprises text and/or images. In another embodiment, the voice option prompt is a Session Initiation Protocol (SIP) message, wherein the session initiation protocol message is expressed in JSON format.

In another embodiment, the voice option prompt can also be a pop-up window or a short message.

The switchboard device can wait for the DTMF signal transmitted by the client device after transmitting the voice option sound and the voice option prompt to the client device, so as to perform subsequent actions corresponding to the DTMF signal.

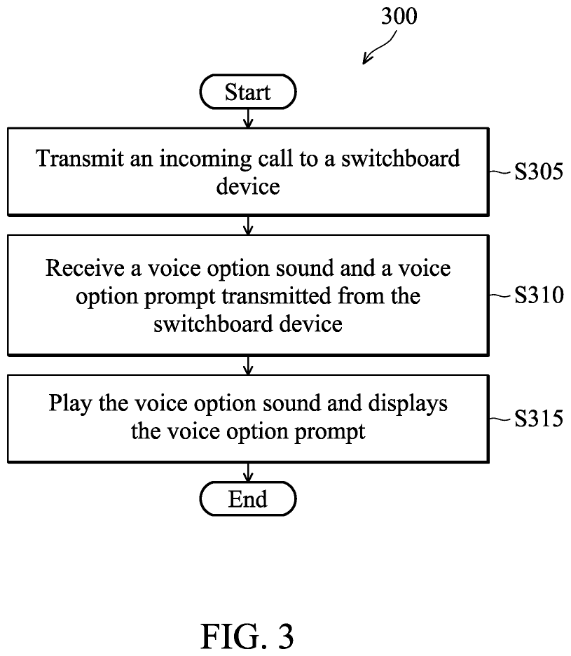

FIG. 3 is a flowchart illustrating a method 300 for providing voice option prompts according to an embodiment of the present disclosure. The method can be executed by the client device 120 of the system 100 for providing voice option prompts as mentioned in FIG. 1.

In step S305, the client device transmits an incoming call to a switchboard device.

In step S310, the client device receives a voice option sound and a voice option prompt transmitted from the switchboard device. In one embodiment, the voice option prompt comprises text and/or images. In another embodiment, the voice option prompt is a Session Initiation Protocol (SIP) message, wherein the session initiation protocol message is expressed in JSON format.

In another embodiment, the voice option prompt can also be a pop-up window or a short message.

In step S315, the client device plays the voice option sound and displays the voice option prompt.

The user using the client device can transmit a DTMF signal through the client device when listening to the voice option sound and watching the voice option prompt, so that the switchboard device can perform subsequent actions corresponding to the DTMF signal.

An example is given below to illustrate that the dialog initiation protocol message carries content in JSON format. The content is expressed in JSON format for displaying icons, and the icons can be used to carry image binary data in JSON format for the client device to decode.

```
{
      “message”: My face (string)
      “face”: d2V3ZXdlZQ== (base64 of image binary data)
}
```

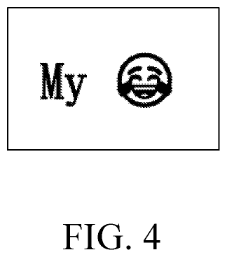

In this example, “face” can be replaced by an image, and the display result can be shown in FIG. 4.

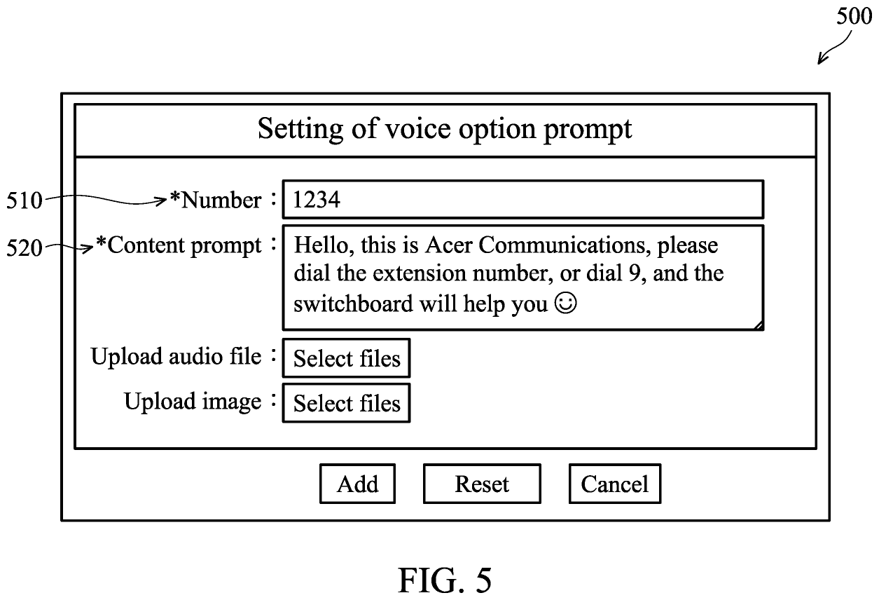

FIG. 5 illustrates a setting interface 500 for setting voice option prompts on the switchboard device according to an embodiment of the present disclosure. As shown in FIG. 5, the setting interface 500 may at least comprise a number 510 of the voice option prompt and the content prompt 520 of the voice option prompt. The switchboard device also provides options for users to upload audio files and images. For example, the number 510 can be, “1234”. For example, the content prompt 520 of the voice option prompt can be, “Hello, this is Acer Communications, please dial the extension number, or dial 9, and the switchboard will help you @”.

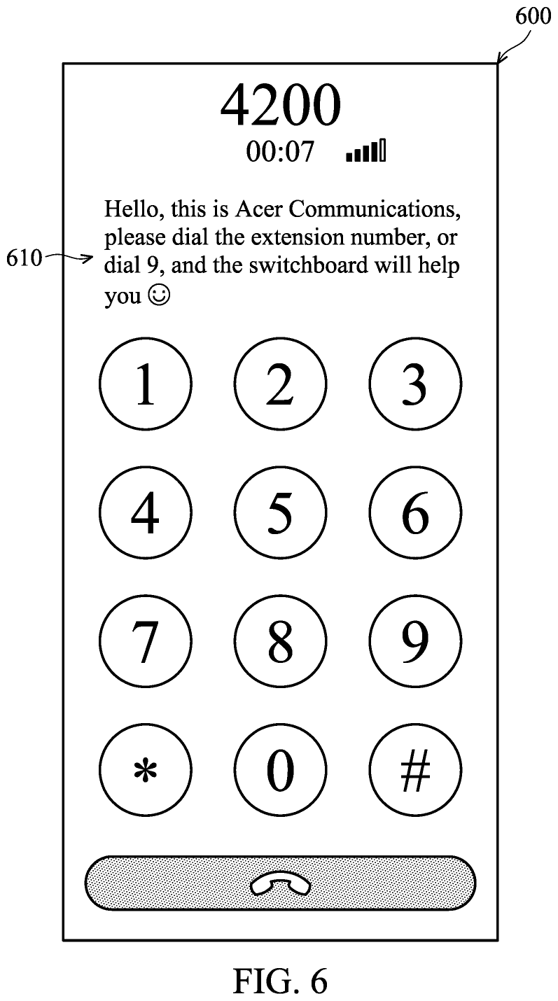

FIG. 6 illustrates a call interface 600 for displaying voice option prompts on a client device according to an embodiment of the present disclosure. As shown in the FIG. 6, the call interface 600 on the screen of the client device can display a voice option prompt 610, wherein the voice option prompt 610 can comprise text and images. For example, the voice option prompt 610 can be “Hello, this is Acer Communications, please dial the extension number, or dial 9, and the switchboard will help you [symbol] ”.

As mentioned above, in the method and device for providing voice option prompts provided in the present disclosure, the switchboard device not only provides voice option prompts, but also transmits text descriptions or images so that users who use the client device can directly watch the text description without having the client device close to the user's ear. The user can directly operate the follow-up dual-tone multi-frequency operations according to the prompt in the text description, so as to increase the convenience and concealment.

Having described embodiments of the present disclosure, an exemplary operating environment in which embodiments of the present disclosure may be implemented is described below. Referring to FIG. 7, an exemplary operating environment for implementing embodiments of the present disclosure is shown and generally known as a computing device 700. The computing device 700 is merely an example of a suitable computing environment and is not intended to limit the scope of use or functionality of the disclosure. Neither should the computing device 700 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 7, the computing device 700 may include a bus 710 that is directly or indirectly coupled to the following devices: one or more memories 712, one or more processors 714, one or more display components 716, one or more input/output (I/O) ports 718, one or more input/output components 720, and an illustrative power supply 722. The bus 710 may represent one or more kinds of busses (such as an address bus, data bus, or any combination thereof). Although the various blocks of FIG. 7 are shown with lines for the sake of clarity, and in reality, the boundaries of the various components are not specific. For example, the display component such as a display device may be considered an I/O component and the processor may include a memory.

The computing device 700 typically includes a variety of computer-readable media. The computer-readable media can be any available media that can be accessed by computing device 700 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the computing device 700. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 712 may include computer-storage media in the form of volatile and/or nonvolatile memory. The memory may be removable, non-removable, or a combination thereof. Exemplary hardware devices include solid-state memory, hard drives, optical-disc drives, etc. The computing device 700 includes one or more processors that read data from various entities such as the memory 712 or the I/O components 720. The display component(s) 716 present data indications to a user or to another device. Exemplary presentation components include a display device, speaker, printing component, vibrating component, etc.

The I/O ports 718 allow the computing device 700 to be logically coupled to other devices including the I/O components 720, some of which may be embedded. Illustrative components include a microphone, joystick, game pad, satellite dish, scanner, printer, wireless device, etc. The I/O components 720 may provide a natural user interface (NUI) that processes gestures, voice, or other physiological inputs generated by a user. For example, inputs may be transmitted to an appropriate network element for further processing. A NUI may be implemented to realize speech recognition, touch and stylus recognition, facial recognition, biometric recognition, gesture recognition both on screen and adjacent to the screen, air gestures, head and eye tracking, touch recognition associated with displays on the computing device 700, or any combination thereof. The computing device 700 may be equipped with depth cameras, such as stereoscopic camera systems, infrared camera systems, RGB camera systems, or any combination thereof, to realize gesture detection and recognition. Furthermore, the computing device 700 may be equipped with accelerometers or gyroscopes that enable detection of motion. The output of the accelerometers or gyroscopes may be provided to the display of the computing device 700 to carry out immersive augmented reality or virtual reality.

Furthermore, the processor 714 in the computing device 700 can execute the program code in the memory 712 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for providing voice option prompts, used in a switchboard device, comprising:
receiving an incoming call from a client device; and
transmitting a voice option sound and a voice option prompt to the client device.

2. The method for providing voice option prompts as claimed in claim 1, wherein the voice option prompt comprises text and/or images.

3. The method for providing voice option prompts as claimed in claim 1, wherein the voice option prompt is a Session Initiation Protocol (SIP) message.

4. A device for providing voice option prompts, comprising:
one or more processors; and
one or more computer storage media for storing one or more computer-readable instructions, wherein the processor is configured to drive the computer storage media to execute the following tasks:
receiving an incoming call from a client device; and
transmitting a voice option sound and a voice option prompt to the client device.

5. The device for providing voice option prompts as claimed in claim 4, wherein the voice option prompt comprises text and/or images.

6. The device for providing voice option prompts as claimed in claim 4, wherein the voice option prompt is a Session Initiation Protocol (SIP) message.

7. A device for providing voice option prompts, comprising:
one or more processors; and
one or more computer storage media for storing one or more computer-readable instructions, wherein the processor is configured to drive the computer storage media to execute the following tasks:
transmitting an incoming call to a switchboard device;
receiving a voice option sound and a voice option prompt transmitted from the switchboard device; and
playing the voice option sound and displaying the voice option prompt.

8. The device for providing voice option prompts as claimed in claim 7, wherein the voice option prompt is a Session Initiation Protocol (SIP) message.
